(19) United States
(12) Patent Application Publication
(10) Pub. No.: US 2024/0363859 A1
(43) Pub. Date: Oct. 31, 2024

(54) ANODE FOR ALL-SOLID-STATE BATTERY

(71) Applicants: Hyundai Motor Company, Seoul (KR); Kia Corporation, Seoul (KR)

(72) Inventors: Yoon Kwang Lee, Suwon (KR); Yun Sung Kim, Seoul (KR); Ga Hyeon Im, Hwaseong (KR); Kyu Joon Lee, Hwaseong (KR); So Young Lee, Suwon (KR); Hong Seok Min, Yongin (KR)

(21) Appl. No.: 18/531,108

(22) Filed: Dec. 6, 2023

(30) Foreign Application Priority Data
Apr. 27, 2023 (KR) 10-2023-0055388

(51) Int. Cl. H01M 4/583; H01M 4/04; H01M 4/36; H01M 4/62; H01M 10/0562

(52) U.S. Cl. CPC H01M 4/583; H01M 4/0423; H01M 4/0428; H01M 4/366; H01M 4/626; H01M 10/0562; H01M 2004/021; H01M 2004/027; H01M 2300/0068

(57) ABSTRACT

The present disclosure relates to an anode active material for an all-solid-state battery. The anode active material includes a particle and a coating part including a lithiophilic material deposited on the surface of the particle, and may further include a filler part deposited in the particle and including a material alloyable with lithium.

### CROSS-REFERENCE TO RELATED APPLICATION

This application claims under 35 U.S.C. § 119 (a) the benefit of priority to Korean Patent Application No. 10-2023-0055388 filed on Apr. 27, 2023, the entire contents of which are incorporated herein by reference.

### TECHNICAL FIELD

The present disclosure relates to an anode active material for an all-solid-state battery, The anode active material includes a particle and a coating part including a lithiophilic material deposited on the surface of the particle, and may further include a filler part deposited in the particle and including a material alloyable with lithium.

### BACKGROUND

Lithium secondary batteries include a cathode and an anode materials capable of exchanging lithium ions, and an electrolyte responsible for the transport of the lithium ions.

Conventional batteries include a separator for preventing physical contact between a cathode and an anode for the purpose of short circuit prevention. An all-solid-state battery includes a solid electrolyte instead of a separator and a liquid electrolyte. Therefore, the all-solid-state battery has reduced risk of explosion and thus has high safety. In addition, the solid electrolyte theoretically has greater ion transfer characteristics than the liquid electrolyte so that the all-solid-state battery is promising as a next-generation high-power, high-energy battery.

Since all components of the all-solid-state battery are made of solid, electrons and ions are transferred through the interface between particles. Therefore, the interface between materials has a dominant effect on battery characteristics. In order to solve this problem, it is necessary to be able to control the transfer of ions and electrons at the interface, and in the process, a reversible reaction of storage and deintercalation of lithium ions is required. In particular, in graphite-based materials, it is absolutely necessary to solve such problems.

### SUMMARY

In preferred aspects, provided is an anode for an all-solid-state battery having excellent lithium-ion conductivity and storage properties.

Also provided is an anode for an all-solid-state battery having excellent energy density and lifespan characteristics.

A term “all-solid-state battery” as used herein refers to a rechargeable secondary battery that includes an electrolyte in a solid state for transferring ions between the electrodes of the battery. In an aspect, provided is an anode for an all-solid-state battery including an anode active material and a solid electrolyte. In particular, the anode active material includes: a particle comprising a plurality of flake carbon fragments overlapped in multiple layers; and a coating part covering at least a portion of a surface of the particle and including a lithiophilic material.

As used herein, the term “lithiophilic” refers to a material property that has affinity or be attracted toward lithium component (e.g., lithium ion). Often, a lithiophilic material, particular, lithiophilic metal, by forming an alloy or complex with lithium, can be used to control nucleation sites and stabilize Li (Li ion) deposition (e.g., dendrite) via regulation of nucleation overpotential of Li. Exemplary lithiophilic material (e.g., metal) may include lithium (Li), indium (In), gold (Au), silver (Ag), bismuth (Bi), zinc (Zn), aluminum (Al), iron (Fe), tin (Sn), and titanium (Ti).

In certain embodiments, the flake carbon fragments may be in a scale shape or a film shape so those fragment can be layered or staggered with overlapping regions to form a particular shape.

The particles may have a spherical shape, an elliptical shape, or a rod shape.

A shortest distance between one flake carbon fragment and the adjacent flake carbon fragment may range from about 10 nm to about 100 nm. The “distance” as used herein refers to a distance measured along a certain cross section of the particle and measured from the closest points between two adjacent flake carbon fragments (e.g., between two adjacent layers of the flake carbon fragments).

The lithiophilic material may include: one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

The lithophilic material may include: silicon (Si); or an alloy of silicon (Si) and lithium, and the lithiophilic material may be amorphous.

The coating part may have a thickness of about 20 nm to 1,000 nm.

The coating part may cover about 90% or greater of the entire surface of the particle.

An area of an interface between the particles and the solid electrolyte may be about 10% or less of the total area of an interface between the anode active material and the solid electrolyte.

The coating part may prevent contact between the particles and the solid electrolyte, and the anode may not include a solid electrolyte interphase layer due to a side reaction between the particles and the solid electrolyte on the surface of the anode active material.

The anode active material may further include a filling part which is filled in a space between the flake carbon fragments. The filling part includes a material alloyable with lithium. The filling part may include: one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

The filling part may include: silicon (Si); or an alloy of silicon (Si) and lithium, and the alloyable material with lithium may be amorphous.

The anode active material may have an average particle diameter D₅₀ of about 1 μm to 20 μm.

The anode active material may include: an amount of about 40% by weight to 90% by weight of the particles; and an amount of about 10% by weight to 60% by weight of a sum of the coating part and the filling part, the % by weight is based on the total weight of the anode active material.

The anode active material may have a specific surface area of about 0.5 m²/g to 4 m²/g.

The solid electrolyte may include a sulfide-based solid electrolyte.

In another aspect, provided is an all-solid-state battery including the anode as described herein.

Also provided is a vehicle including the all-solid-state battery as described herein.

In another aspect, provided is a method of producing an anode active material for an all-solid-state battery including steps of: forming a particle; depositing a coating part on the particle comprising a lithiophilic material; and optionally depositing a filler part. In particular, the particle includes a plurality of the flake carbon fragments, and the particle is formed by stacking or overlapping the plurality of the flake carbon fragments in multiple layers.

The coating part and/or the filler part may be deposited a chemical vapor deposition (CVD) or a physical vapor deposition (PVD).

The anode for an all-solid-state battery provided herein may have excellent lithium-ion conductivity and storage properties. Also, the anode for an all-solid-state battery as provided herein may have excellent energy density and lifespan characteristics.

Other aspects of the invention are disclosed infra.

### BRIEF DESCRIPTION OF THE DRAWINGS

FIG. 1 shows an exemplary all-solid-state battery according to an exemplary embodiment of the present disclosure.

FIG. 2 shows an exemplary anode active material according to an exemplary embodiment of the present disclosure.

FIG. 3 shows an exemplary particle in an exemplary anode active material according to an exemplary embodiment of the present disclosure.

FIG. 4 shows movement of lithium ions (Li⁺) between an exemplary anode active material and an exemplary solid electrolyte in the anode according to an exemplary embodiment of the present disclosure.

FIG. 5A shows an anode active material at the beginning of charging.

FIG. 5B shows an anode active material when charging is sufficiently performed.

FIG. 6 shows a cross section of an anode active material according to a Preparation Example using a scanning electron microscope.

FIG. 7 shows an X-ray spectroscopic analysis result for an anode according to Example 1.

FIG. 8 shows a first charge/discharge graph of a half-cell including an anode according to Example 1.

FIG. 9 shows a first charge/discharge graph of a half-cell including an anode according to Comparative Example 1.

FIG. 10 shows a high rate charge/discharge graph of a half-cell including an anode according to Example 1.

FIG. 11 shows a high rate charge/discharge graph of a half-cell including an anode according to Comparative Example 1.

FIG. 12 shows the capacity retention rate of a full cell according to Comparative Example 2.

FIG. 13 shows the capacity retention rate of a full cell according to Example 2.

### DETAILED DESCRIPTION

The above objects, other objects, features and advantages of the present disclosure will be easily understood through the following preferred embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, dimensions of the structures are shown enlarged than actual for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part, but also the case where there is another part in the middle therebetween. Conversely, when a part of a layer, film, region, plate, etc. is said to be “under” other part, this includes not only the case where it is “directly under” the other part, but also the case where there is another part in the middle therebetween.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, when a numerical range is disclosed in this description, such a range is continuous, and includes all values from a minimum value of such a range to the maximum value including a maximum value, unless otherwise indicated. Furthermore, when such a range refers to an integer, all integers including from the minimum value to the maximum value including a maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

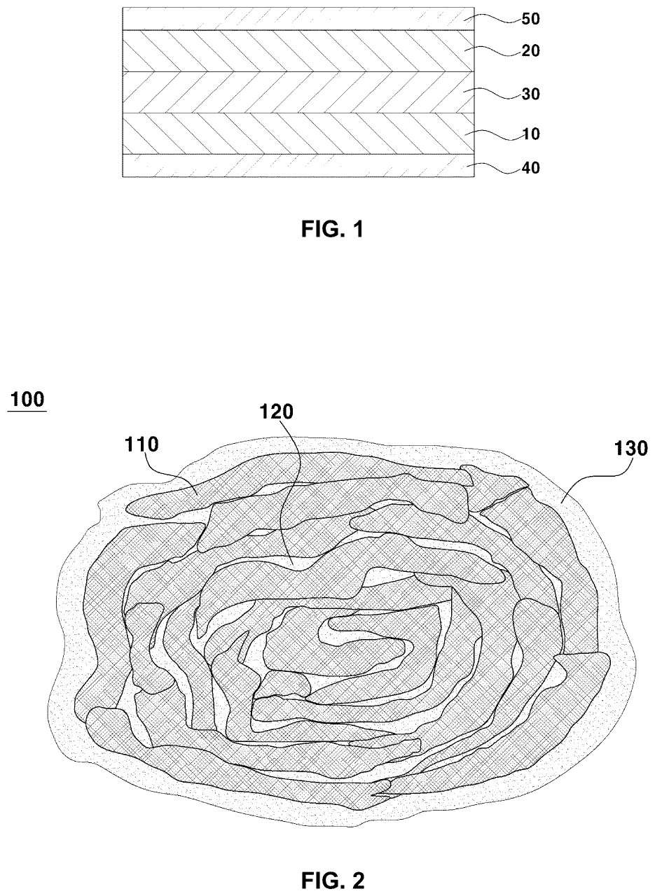

FIG. 1 shows an exemplary all-solid-state battery according to an exemplary embodiment of the present disclosure. The all-solid-state battery may include an anode 10, a cathode 20, and a solid electrolyte layer 30 interposed between the anode 10 and the cathode 20. An anode current collector 40 may be attached to the anode 10, and a cathode current collector 50 may be attached to the cathode 20.

The anode 10 may be in the form of a sheet having at least two opposing main surfaces. Each of the two main surfaces may include not only a mathematical plane, but also a certain curved surface in part thereof, and may have irregularities generated in the fabrication of the anode 10. In this sense, the sheet shape is not limited to a relatively thin cuboid.

In the sheet-shaped anode 10, a distance between the two opposing main surfaces may be a thickness of the anode 10. A length of the anode 10 in a first direction (for example, the width direction) orthogonal to the thickness direction thereof is greater than a thickness thereof. In addition, a length of the anode 10 in a second direction (e.g., a longitudinal direction) orthogonal to each of the thickness direction of the anode 10 and the first direction is greater than the thickness thereof.

The thickness of the anode 10 is not particularly limited, but may be about 1 μm to 100 μm. The thickness of the anode 10 may mean an average value when five point-measuring a measurement target. In addition, the thickness of the anode 10 may mean the thickness of the all-solid-state battery during discharging.

The anode 10 may include an anode active material, a solid electrolyte, a binder, and the like.

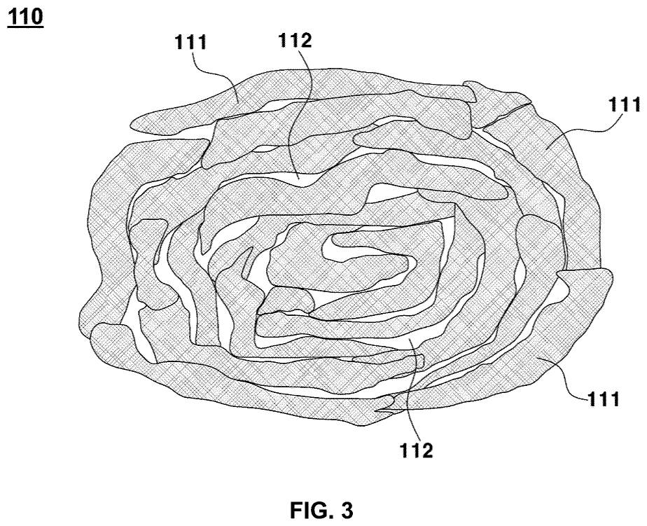

FIG. 2 shows an exemplary anode active material 100 according to an exemplary embodiment of the present disclosure. The anode active material 100 may include a particle 110 having a predetermined shape, a filling part 120 which is filled in the particle 110 and includes an alloyable material with lithium, and a coating part 130 which is covered on at least a portion of a surface of the particle 110 and includes a lithiophilic material.

A conventional all-solid-state battery includes a graphite-based anode active material. Lithium ions (Li⁺) are intercalated and deintercalated into the graphite-based anode active material, and charging and discharging proceed. Since the liquid electrolyte is impregnated inside and outside of the graphite-based anode active material in a lithium-ion battery using a liquid electrolyte, there is no problem in the movement of the lithium ions. However, since lithium ions are smoothly conducted at the contact portion between the surface of the graphite-based anode active material and the solid electrolyte in an all-solid-state battery using a solid electrolyte, but only a diffusion-induced movement thereof is possible inside the graphite-based anode active material, the transmission path of the lithium ions becomes very long. That is, there is a problem in that, at room temperature or low temperature where the movement speed by diffusion is low, the output of the all-solid-state battery is very low, and lithium is easily precipitated.

In addition, in the conventional all-solid-state battery, a solid electrolyte interphase layer is formed by oxidation/reduction reactions of carbon, solid electrolyte, lithium ions (Li⁺), and electrons at the interface between the graphite-based anode active material and the solid electrolyte. The solid electrolyte interphase layer induces depletion of lithium in the battery and hinders intercalation and deintercalation of lithium ions (Li⁺). In addition, it induces the formation of lithium dendrites on the surface of the solid electrolyte, thereby reducing the lifespan of the battery.

The present disclosure is to solve the problems of the conventional graphite-based anode active material as described above and is characterized in that an alloyable material with lithium and a lithiophilic material are sufficiently deposited on the inside and the surface of the particles 110 to increase the lithium ion conductivity within the anode active material 100 and prevent side reactions between the particles 110 and the solid electrolyte while making the interface between the anode active material 100 and the solid electrolyte even.

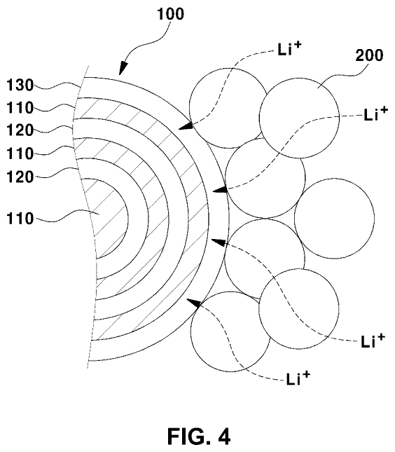

FIG. 3 shows an exemplary particles 110 according to an exemplary embodiment of the present disclosure. The particles 110 may include a plurality of flake carbon fragments 111 overlapped in multiple layers and spaces 112 between the flake carbon fragments 111.

For example, the particle 110 is formed of the plurality of the flake carbon fragments 111 having a concentric shape (e.g., a cabbage shape), or randomly assembled. Although the particles 110 of FIG. 3 are spherical, the shape of the particles 110 is not limited thereto, and the shape of the particles 110 may be an elliptical shape, a rod shape, or the like.

The flake carbon fragments 111 may be thin plate-like pieces having a scale-like shape.

A shortest distance between one flake carbon fragment 111 and the adjacent flake carbon fragment may be measured be about 10 nm to 100 nm. The shortest distance may be measured in a certain cross-section of the particle and refers to a distance between one layer and another layer when the flake carbon fragments 111 are stacked to form multiple layers. In addition, the shortest distance may mean the size of the spaces 112 based on the cross sections of the flake carbon fragment 111. When the shortest distance is less than about 10 nm, it may be difficult for the filling part 120 to be deposited in the spaces 112, and when the shortest distance is greater than about 100 nm, the conductivity of lithium ions (Li⁺) in the anode active material 100 may decrease.

The spaces 112 may be pores in the particles 110 generated in the process of assembling the flake carbon fragments 111 by overlapping them in several layers. The spaces 112 may be formed continuously or intermittently from the surface of the particles 110 to the center of the particles 110.

The filling part 120 may be filled in the spaces 112 between the flake carbon fragments 111. In addition, the filling part 120 may include a material alloyable with lithium. The lithium alloy may attract lithium ions (Li⁺) to increase the diffusion movement rate of the lithium ions (Li⁺).

As described above, since the spaces 112 may be continuously formed from the surface of the particles 110 to the center of the particles 110, lithium ions (Li⁺) may move more easily within the anode active material 100 when the filling part 120 is filled in the spaces 112. Therefore, even if the all-solid-state battery according to the present disclosure is operated at room temperature or low temperatures, problems such as power output degradation and excessive lithium precipitation may not occur. This will be described later.

The filling part 120 may occupy about 80% or greater of the spaces 112 based on the total volume of the spaces 112. When the filling rate of the filling part 120 is less than about 80%, the movement of lithium ions (Li⁺) within the anode active material 100 may be inefficient. The upper limit of the filling rate of the filling part 120 is not particularly limited, and may be about 100% or less, about 99% or less, about 95% or less, or about 90% or less.

The filling part 120 may include: one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge) or an alloy thereof with lithium.

Preferably, the filling part 120 may include silicon (Si) or an alloy of silicon (Si) and lithium. More preferably, the filling part 120 may suitably include amorphous silicon (Si) or an alloy of amorphous silicon (Si) and lithium. Since amorphous silicon undergoes isotropic expansion, deformation and deintercalation of the first material 120 may be minimized, and lithium ions (Li⁺) may also be easily transferred between the first material 120 and the particles 110.

The coating part 130 may be covered on at least a portion of the surface of the particles 110. The coating part 130 may prevent the particles 110 from contacting the solid electrolyte. When the particles 110 are exposed to the outside and contact a solid electrolyte, the solid electrolyte may be decomposed due to high electronic conductivity of the particles 110.

The coating part 130 may include a lithiophilic material. Since the coating part 130 covers most of the surface of the particles 110, lithium ions (Li⁺) conducted through the solid electrolyte may be more quickly inserted into the anode active material 100 than when the coating part 130 is not present. This is because the coating part 130 transfers lithium ions (Li⁺) at a rate faster than that of the particles 110.

The coating part 130 may cover about 90% or greater of the entire surface area of the particles 110. The upper limit of the coverage of the coating part 130 is not particularly limited, and may be about 100% or less, about 99% or less, or about 95% or less.

The coating part 130 may have a thickness of about 20 nm to 1,000 nm. The thickness of the coating part 130 may be measured by, for example, observation using a transmission electron microscope (TEM). The number of samples is preferably large, and for example, the thickness of the coating part 130 formed on 10 or greater, preferably 100 or greater anode active materials 100 may be measured and calculated as an average value. When the thickness is less than 20 nm, the coating part 130 may not sufficiently cover the surface of the particles 110, and when the thickness is greater than about 1,000 nm, productivity may decrease, and the coating part 130 may adversely affect the physical properties of the anode active material 100.

The coating part 130 may include: one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

Preferably, the coating part 130 may include silicon (Si) or an alloy of silicon (Si) and lithium. More preferably, the coating part 130 may suitably include amorphous silicon (Si) or an alloy of amorphous silicon (Si) and lithium. Since amorphous silicon undergoes isotropic expansion, deformation and deintercalation of the coating part 130 may be minimized, and lithium ions (Li⁺) may also be easily transferred between the coating part 130 and the particles 110.

The anode active material 100 may include the particles 110 in an amount of about 40% by weight to 90% by weight and a sum of the filling part 120 and the coating part 130 in an amount of about 10% by weight to 60% by weight. The % by weight is based on the total weight of the anode active material. When the total weight of the filling part 120 and the coating part 130 is less than about 10% by weight, the filling part 120 may not sufficiently fill the spaces 112, or the coating part 130 may not sufficiently cover the surface of the particles 110. When the total weight of the filling part 120 and the coating part 130 is greater than about 60% by weight, the coating part 130 may become excessively thick.

The anode active material 100 may have an average particle diameter D₅₀ of about 1 μm to 20 μm. The average particle diameter D₅₀ may be measured using a commercially available laser diffraction scattering-type particle size distribution measuring device, for example, a micro track particle size distribution measuring device. Alternatively, 200 particles may be randomly extracted from the electron micrograph and the average particle diameter may be calculated. When the average particle diameter D₅₀ of the anode active material 100 is about 1 μm or greater, the density of the anode 10 may be increased to improve the discharge capacity per volume, and when it is about 20 μm or less, chargeability and cycle characteristics may be improved.

The anode active material 100 may have a specific surface area of about 0.5 m²/g to 4 m²/g. The specific surface area may be measured by the Brunauer-Emmett-Teller (BET) method by nitrogen adsorption, and for example, a commonly used specific surface area measuring instrument (MOUNTECH's Macsorb HM (Model 1210) or MicrotracBEL's Belsorp-mini, etc.) may be used. When the specific surface area falls within the above-described numerical range, it may be advantageous to suppress volume expansion of the anode active material 100.

A preparation method of the anode active material 100 is not particularly limited. As shown in FIG. 3, after preparing particle 110 having a predetermined shape by overlapping of flake carbon fragments 111 in multiple layers, the anode active material 100 may be prepared by depositing a metal or metalloid element corresponding to the filling part 120 and coating part 130 on the particles 110. The deposition may be, for example, a chemical vapor deposition (CVD) method, a physical vapor deposition (PVD) method, etc., and it may be preferable to perform the deposition by chemical vapor deposition considering filling rate of the filling part 120, coverage of the coating part 130, and even thickness of the coating part 130.

In addition, the anode active material 100 may be prepared in the form of a secondary particle by depositing silicon or the like on the surface of the flake carbon fragments 111 to prepare a primary particle and then bonding a plurality of the primary particles. When the deposited material such as silicon exists inside the secondary particles, it may become a filling part 120, and when it is covered on the surface of the secondary particles, it may become a coating part 130.

The anode 10 may include a solid electrolyte having lithium-ion conductivity. The solid electrolyte may include an oxide-based solid electrolyte or a sulfide-based solid electrolyte. It may be preferable to use a sulfide-based solid electrolyte having high lithium-ion conductivity.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂-LiₓMO_{y} (provided that x and y are positive numbers, and M is one of P, Si, Ge, B, Al, Ga, and In), Li₁₀GeP₂S₁₂, or the like.

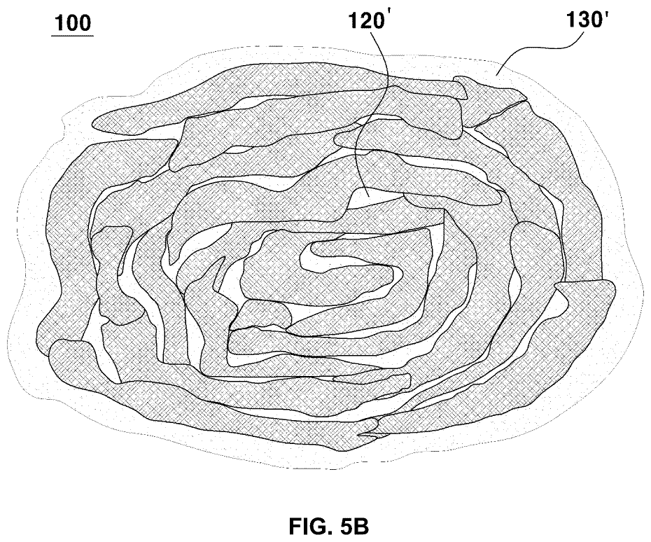

FIG. shows movement of lithium ions (Li⁺) between an anode active material 100 and a solid electrolyte 200 in the anode 10 according to the present disclosure. FIG. 5A shows an anode active material 100 at the beginning of charging. FIG. 5B shows an anode active material 100 when charging is sufficiently performed.

The anode active material 100 and the solid electrolyte 200 may form an interface in the anode 10, and since the anode active material 100 includes the coating part 130 on the surface of the particles 110, the contact area between the particles 110 and the solid electrolyte 200 may be about 10% or less, 5% or less, 3% or less, or 1% or less of the area of the interface between the anode active material 100 and the solid electrolyte 200.

During charging of the all-solid-state battery, lithium ions (Li⁺) that have moved from the cathode 20 to the anode 10 are inserted into the anode active material 100 through the solid electrolyte 200 having lithium-ion conductivity in the anode 10.

Since the coating part 130 covers most of the surface of the particles 110, the particles 110 may not come into contact with the solid electrolyte 200. Therefore, a solid electrolyte interphase layer that is due to oxidation and reduction reactions of the particles 110, the solid electrolyte 200, lithium ions (Li⁺), and electrons may not exist on the surface of the anode active material 100. The solid electrolyte interphase layer induces the depletion of lithium in the all-solid-state battery and hinders the intercalation and deintercalation of lithium ions (Li⁺), and the present disclosure is characterized in that the above-described problem is solved by covering the coating part 130 on the surface of the particles 110.

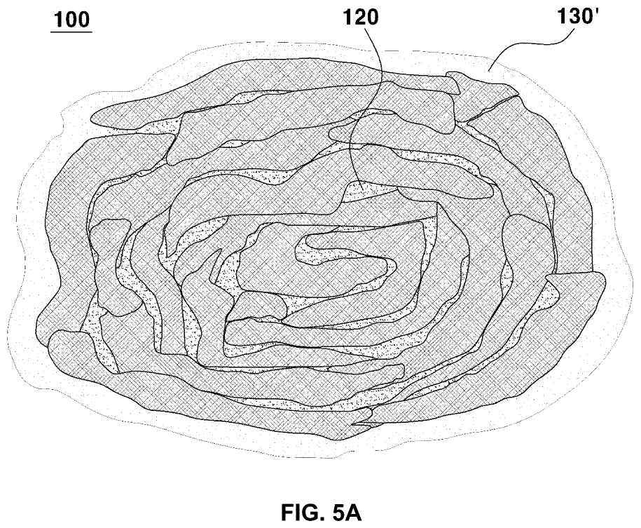

As shown in FIGS. 4 and 5A, lithium ions (Li⁺) conducted to the anode active material 100 through the solid electrolyte 200 in the initial stage of charging react with the coating part 130 to form an outer lithium alloy 130′.

When charging is further performed, the lithium ion (Li⁺) may diffuse and move into the anode active material 100. The lithium ions (Li⁺) are inserted into the particles 110, and the filling part 120 filled in the particles 110 may react with the lithium ions (Li⁺) to form an inner lithium alloy 120′ as shown in FIG. 5B. The inner lithium alloy 120′ may serve as a transfer path for the lithium ions (Li⁺), and thus the diffusion movement speed of the lithium ions (Li⁺) is increased.

Thereafter, when lithium ions (Li⁺) are further diffused into the anode active material 100, and thus when the lithium ions (Li⁺) are inserted into the particle 110 until the receiving amount of the particle 110 is reached, filling is completed.

Since lithium ions (Li⁺) have a short transfer path and a fast diffusion rate in the anode active material 100, the all-solid-state battery according to the present disclosure may be driven at room temperature or low temperatures, and may be normally operated even when the output is increased.

The anode 10 may include a binder. The binder may attach the anode active material 100 and the solid electrolyte 200.

The type of the binder is not particularly limited, and examples thereof may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The anode 100 may include an amount of about 80% by weight to 85% by weight of the anode active material 100, about 10% by weight to 15% by weight of the solid electrolyte 200, and about 1% by weight to 5% by weight of the binder, based on the total weight of the anode. However, the content of each component may be appropriately adjusted in consideration of the capacity, efficiency, etc. of a desired all-solid-state battery.

The cathode 20 may be in the form of a sheet having at least two opposing main surfaces. Each of the two main surfaces may include not only a mathematical plane, but also a certain curved surface in part thereof, and may have irregularities generated in the fabrication of the cathode 20. In this sense, the sheet shape is not limited to a relatively thin cuboid.

In the sheet-shaped cathode 20, a distance between the two opposing main surfaces may be a thickness of the cathode 20. A length of a first direction (for example, the width direction) orthogonal to the thickness direction of the cathode 20 is greater than a thickness thereof. In addition, a length in a second direction (e.g., a longitudinal direction) orthogonal to each of the thickness direction and the first direction of the cathode 20 is greater than the thickness thereof.

The thickness of the cathode 20 is not particularly limited, but may be about 1 μm to 100 μm. The thickness of the cathode 20 may mean an average value when five point-measuring a measurement target. In addition, the thickness of the cathode 20 may mean the thickness of the all-solid-state battery during discharging.

The cathode 20 may include a cathode active material, a solid electrolyte, a conductive material, a binder, and the like.

The cathode active material may occlude and release lithium ions.

The cathode active material may include a rock salt layer-type active material such as LiCoO₂, LiMnO₂, LiNiO₂, LiVO₂, Li₁₊ₓNi_{1/3}Co_{1/3}Mn_{1/3}O₂, or the like, a spinel-type active material such as LiMn₂O₄, Li(Ni_{0.5}Mn_{1.5})O₄, or the like, a reverse spinel-type active material such as LiNiVO₄, LiCoVO₄, or the like, an olivine-type active material such as LiFePO₄, LiMnPO₄, LiCoPO₄, LiNiPO₄, or the like, a silicon-containing active material such as Li₂FeSiO₄, Li₂MnSiO₄, or the like, a rock salt layer-type active material in which a part of the transition metal is substituted with a dissimilar metal, such as LiNi_{0.8}Co_{(0.2-x)}AlₓO₂ (0<x<0.2), a spinel-type active material in which a part of the transition metal is substituted with a dissimilar metal, such as Li₁₊ₓMn_{2-x-y}M_{y}O₄ (M is at least one of Al, Mg, Co, Fe, Ni, and Zn, and 0<x+y<2), or a lithium titanate such as Li₄Ti₅O₁₂ or the like.

The solid electrolyte may include an oxide-based solid electrolyte or a sulfide-based solid electrolyte. It may be preferable to use a sulfide-based solid electrolyte having high lithium-ion conductivity. The sulfide-based solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂-LiₓMO₇ (provided that x and y are positive numbers, and M is one of P, Si, Ge, B, Al, Ga, and In), Li₁₀GeP₂S₁₂, or the like. The solid electrolyte included in the cathode 20 may be the same as or different from the solid electrolyte included in the anode 10.

The conductive material may include carbon black, conductive graphite, ethylene black, graphene, and the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder included in the cathode 20 may be the same as or different from the binder included in the anode 10.

The solid electrolyte layer 30 may be in the form of a sheet having at least two opposing main surfaces. Each of the two main surfaces may include not only a mathematical plane, but also a certain curved surface in part thereof, and may have irregularities generated in the fabrication of the solid electrolyte layer 30. In this sense, the sheet shape is not limited to a relatively thin cuboid.

In the sheet-shaped solid electrolyte layer 30, a distance between the two opposing main surfaces may be a thickness of the solid electrolyte layer 30. A length of a first direction (for example, the width direction) orthogonal to the thickness direction of the solid electrolyte layer 30 is greater than a thickness thereof. In addition, a length in a second direction (e.g., a longitudinal direction) orthogonal to each of the thickness direction and the first direction of the solid electrolyte layer 30 is greater than the thickness thereof.

The thickness of the solid electrolyte layer 30 is not particularly limited, but may be about 1 μm to 100 μm. The thickness of the solid electrolyte layer 30 may mean an average value when five point-measuring a measurement target.

The solid electrolyte layer 30 may include a solid electrolyte having lithium-ion conductivity. The solid electrolyte may include at least one selected from the group consisting of an oxide-based solid electrolyte, a sulfide-based solid electrolyte, and a combination thereof. In addition, the solid electrolyte may be crystalline, amorphous, or a mixed state thereof.

The oxide-based solid electrolyte may include perovskite-type Li₃ₓLa_{2/3-x}TiO₃ (LLTO), phosphate-based NASICON-type Li₁₊ₓAlₓTi₂₋ₓ(PO₄)₃ (LATP), and the like.

The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂-LiₓMO_{y} (provided that x and y are positive numbers, and M is one of P, Si, Ge, B, Al, Ga, and In), Li₁₀GeP₂S₁₂, or the like.

Preferably, the solid electrolyte may include a sulfide-based solid electrolyte having an argyrodite crystal structure. The sulfide-based solid electrolyte having the argyrodite crystal structure may include at least one selected from the group consisting of Li₇₋ₓPS₆₋ₓClₓ (0<x≤2), Li₇₋ₓPS₆₋ₓBrₓ (0<x≤2), Li₇₋ₓPS₆₋ₓIₓ (0<x≤2), and combinations thereof.

The anode current collector 40 may be a plate-shaped substrate having electrical conductivity. Specifically, the anode current collector 40 may have the form of a sheet, thin film or foil.

The anode current collector 40 may include a material that does not react with lithium. Specifically, the anode current collector 10 may include at least one selected from the group consisting of nickel (Ni), copper (Cu), stainless steel, and combinations thereof.

The thickness of the anode current collector 40 is not particularly limited, and may be, for example, about 1 μm to 500 μm.

The cathode current collector 50 may include a plate-shaped substrate having electrical conductivity. Specifically, the cathode current collector 50 may have the form of a sheet, thin film or foil.

The cathode current collector 50 may include an aluminum foil.

The thickness of the cathode current collector 50 is not particularly limited, and may be, for example, about 1 μm to 500 μm.

### EXAMPLE

Another Exemplary embodiment embodiments of the present disclosure will be described in more detail through the following examples. The following Examples are merely examples to aid understanding of the present disclosure, and the scope of the present disclosure is not limited thereto.

### Preparation Example

Particles having a shape close to a spherical or elliptical shape were prepared by overlapping flake carbon fragments in multiple layers. Silicon was deposited on the inside and surfaces of the particles by a chemical vapor deposition method. Specifically, after the particles were introduced into the chamber and the chamber was evacuated, a reaction gas containing silicon was injected into the chamber. An anode active material was prepared by heating the inside of the chamber to a predetermined temperature and depositing silicon contained in the reaction gas on the inside and surfaces of the particles as a filling part and a coating part, respectively.

The anode active material according to the present Preparation Example includes about 70% by weight of the particles and about 30% by weight of the sum of the filling part and the coating part.

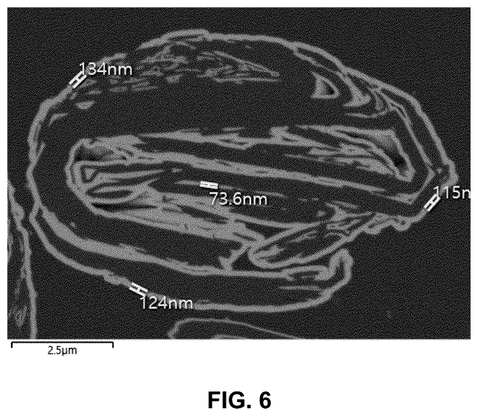

FIG. 6 shows a cross section of an anode active material according to Preparation Example using a scanning electron microscope. The dark part represents particles in which flake carbon fragments are overlapped in multiple layers and rounded, and the bright parts are the filling part and the coating part. Referring to this, it can be seen that the coating part covered on the surface of the particles had a thickness of about 20 nm to 1,000 nm, and was formed evenly with slight variation in thickness.

### Comparative Preparation Example 1

The particles of Preparation Example in which silicon was not deposited were set as Comparative Preparation Example 1.

### Comparative Preparation Example 2

An anode active material was prepared in the same manner as in Preparation Example except that the anode active material included about 95% by weight of the particles and about 5% by weight of the sum of the filling part and the coating part.

### Example 1

A slurry was prepared by introducing the anode active material according to Preparation Example, a sulfide-based solid electrolyte, and a binder into a solvent. The slurry was applied onto an anode current collector to form an anode having a thickness of about 50 μm. Nitrile butadiene rubber (NBR) was used as the binder, and hexyl butyrate was used as the solvent.

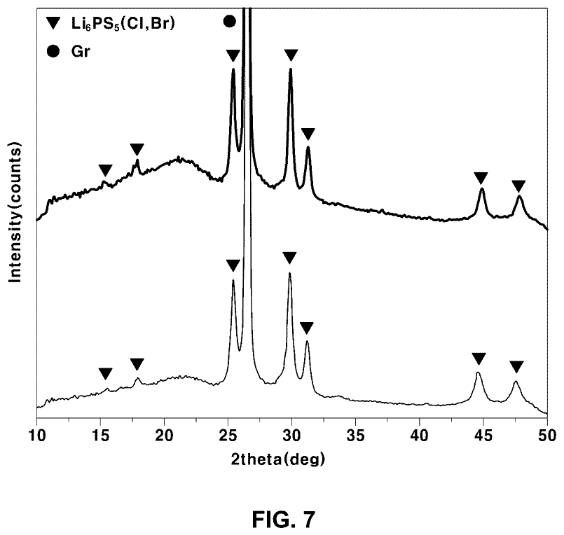

FIG. 7 shows an X-ray spectroscopic analysis result for an anode according to Example 1. The lower result is the result for the anode immediately after fabrication, and the upper result is the result for the anode after 2 weeks. The silicon deposited on the anode active material was amorphous in light of the fact that peaks due to the solid electrolyte and particles were found, whereas peaks due to silicon were not found.

A solid electrolyte layer containing a sulfide-based solid electrolyte was laminated on the anode, and lithium metal was laminated on the solid electrolyte layer to configure a half-cell.

### Comparative Example 1

A half-cell was configured in the same manner as in Example 1 except that the anode active material according to Comparative Preparation Example 1 was used.

### Experimental Example 1

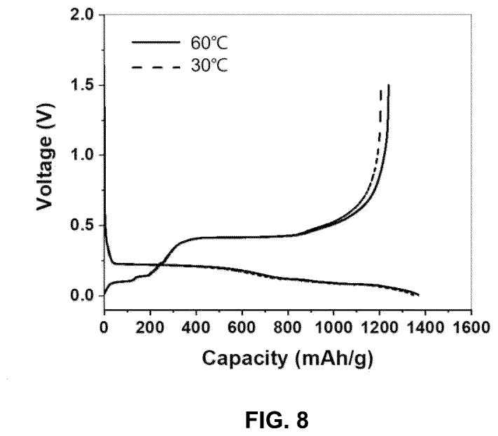

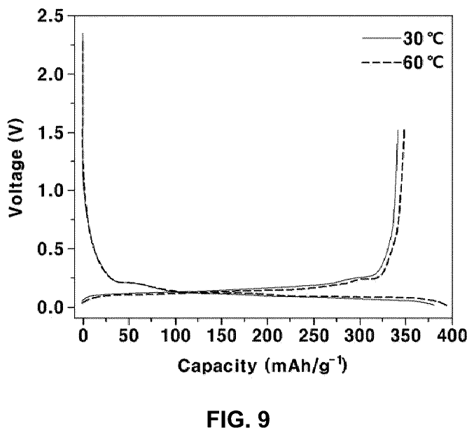

FIG. 8 shows first charge/discharge graph of a half-cell including an anode according to Example 1. FIG. 9 shows first charge/discharge graph of a half-cell including an anode according to Comparative Example 1. The properties of the half-cells were evaluated at a temperature of 30° C. and 60° C., respectively.

Comparative Example 1 shows relatively high reactivity in the initial charging reaction (>0.5 V), and this is a reaction that forms an irreversible resistive layer and is not seen in the results of Example 1.

When evaluated at the temperature of 30° C., the initial efficiency of Example 1 was about 91.8%, and the initial efficiency of Comparative Example 1 was about 89.5%. When evaluated at the temperature of 60° C., the initial efficiency of Example 1 was about 90.0%, and the initial efficiency of Comparative Example 1 was about 88.2%.

### Experimental Example 2

Charge/discharge characteristics were evaluated in the same manner as above by increasing the current density to 2 mA/cm². The deposition capacity was set to 3.5 mAh/cm².

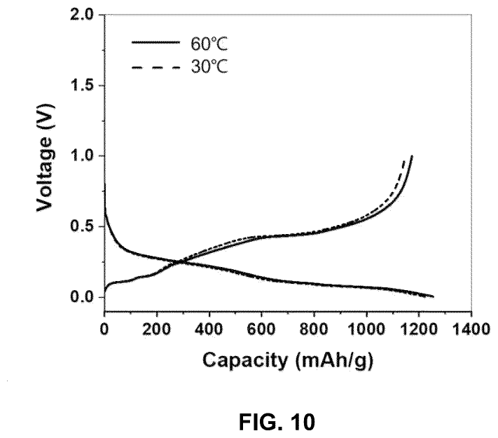

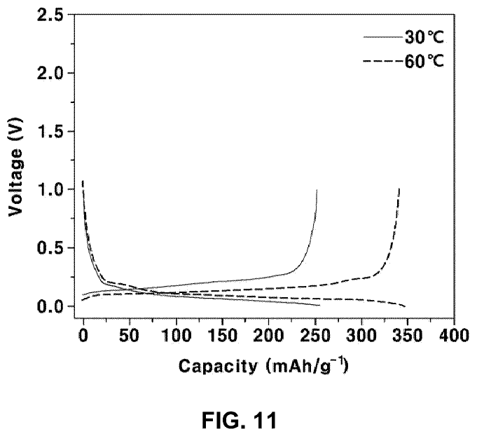

FIG. 10 shows high rate charge/discharge graph of a half-cell including an anode according to Example 1. FIG. 11 shows high rate charge/discharge graph of a half-cell including an anode according to Comparative Example 1. The properties of the half-cells were evaluated at a temperature of 30° C. and 60° C., respectively.

As shown in FIG. 11, Comparative Example 1 shows a significant difference in capacity realization by temperature. Lithium insertion was not smooth at low temperatures where lithium movement was limited, and this occurred since lithium movement between the surface of the particles and the solid electrolyte was not smooth. In addition, the solid electrolyte interphase layer formed at the interface between the particles and the solid electrolyte may act as resistance and accelerate it.

As shown in FIG. 10, the deviation by temperature of lithium stored in the anode active material was rapidly reduced in Example 1. This is a result of the filling part and the coating part contributing to the rapid movement of lithium into the anode active material.

### Example 2

A solid electrolyte layer containing a sulfide-based solid electrolyte was laminated on the anode according to Example 1, and a cathode including a cathode active material, a solid electrolyte, a conductive material, and a binder was laminated on the solid electrolyte layer to configure a full cell. Nickel-cobalt-manganese oxide was used as the cathode active material.

### Comparative Example 2

A full cell was configured in the same manner as in Example 2 except that the anode active material according to Comparative Preparation Example 2 was used.

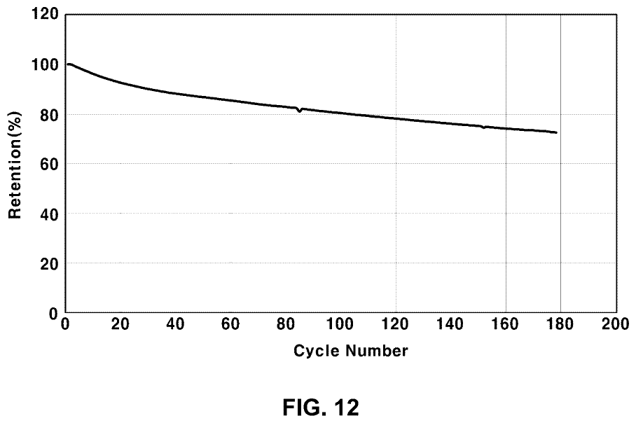

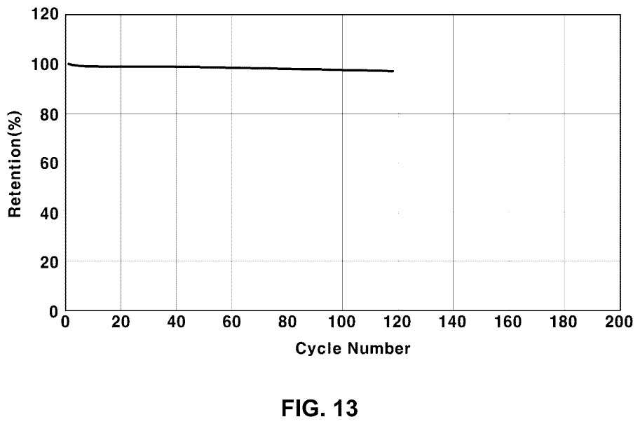

FIG. 12 shows the capacity retention rate of a full cell according to Comparative Example 2. FIG. 13 shows the capacity retention rate of a full cell according to Example 2. Example 2, in which silicon was sufficiently deposited on the inside and surfaces of the particles due to the high content of the filling part and the coating part, had an exceptionally excellent capacity retention rate and was stably driven compared to Comparative Example 2.

Since the exemplary embodiments of the present disclosure have been described in detail above, the scope of rights of the present disclosure is not limited to the above-described embodiments, and various modifications and improved forms of those skilled in the art using the basic concept of the present disclosure defined in the following claims are also included in the scope of rights of the present disclosure.

What is claimed is:

1. An anode for an all-solid-state battery comprising an anode active material and a solid electrolyte,
wherein the anode active material comprises:
a particle comprising a plurality of flake carbon fragments overlapped in multiple layers; and
a coating part covering at least a portion of a surface of the particle and comprising a lithiophilic material.

2. The anode of claim 1, wherein the particle is formed in a spherical shape, an elliptical shape, or a rod shape.

3. The anode of claim 1, wherein a shortest distance between one flake carbon fragment and the adjacent flake carbon fragment is about 10 nm to 100 nm.

4. The anode of claim 1, wherein the lithiophilic material comprises: one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

5. The anode of claim 1, wherein the lithophilic material comprises silicon (Si) or an alloy of silicon (Si) and lithium, and
wherein the lithiophilic material is amorphous.

6. The anode of claim 1, wherein the coating part has a thickness of about 20 nm to 1,000 nm.

7. The anode of claim 1, wherein the coating part covers about 90% or greater of the entire surface of the particles.

8. The anode of claim 1, wherein an area of an interface between the particle and the solid electrolyte is about 10% or less of a total area of an interface between the anode active material and the solid electrolyte.

9. The anode of claim 1, wherein the coating part prevents contact between the particle and the solid electrolyte, and the anode does not comprise a solid electrolyte interphase layer due to a side reaction between the particle and the solid electrolyte on the surface of the anode active material.

10. The anode of claim 1, wherein the anode active material further comprises a filling part which is filled in a space between the plurality of the flake carbon fragments, wherein the filling part comprises a material alloyable with lithium.

11. The anode of claim 10, wherein the filling part comprises: one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge); or an alloy thereof with lithium.

12. The anode of claim 10, wherein the filling part comprises silicon (Si), and
wherein the material alloyable with lithium is amorphous.

13. The anode of claim 1, wherein the anode active material has an average particle diameter D₅₀ of about 1 μm to 20 μm.

14. The anode of claim 10, wherein the anode active material comprises:
an amount of about 40% by weight to 90% by weight of the particle; and
an amount of about 10% by weight to 60% by weight of a sum of the coating part and the filling part,
the % by weight is based on the total weight of the anode active material.

15. The anode of claim 1, wherein the anode active material has a specific surface area of about 0.5 m²/g to 4 m²/g.

16. The anode of claim 1, wherein the solid electrolyte comprises a sulfide-based solid electrolyte.

17. An all-solid-state battery comprising an anode of claim 1.

18. A vehicle comprising an all-solid battery of claim 17.

19. A method of producing an anode active material for an all-solid-state battery comprising:
forming a particle, wherein the particle comprises a plurality of the flake carbon fragments and the particle is formed by stacking or overlapping the plurality of the flake carbon fragments in multiple layers;
depositing a coating part on the particle comprising a lithiophilic material; and
optionally depositing a filler part

20. The method of claim 19, wherein the coating part and/or the filler part is deposited a chemical vapor deposition (CVD) or a physical vapor deposition (PVD).
